(19) United States
(12) Patent Application Publication
(10) Pub. No.: US 2007/0283374 A1
(43) Pub. Date: Dec. 6, 2007

(54) Motor-fixed structure of optical disc device

(75) Inventor: Chun-Lung Ho, Hsinchu City (TW)

Correspondence Address: SINORICA, LLC, 528 FALLSGROVE DRIVE, ROCKVILLE, MD, 20850, US

(73) Assignee: Lite-On It Corporation

(21) Appl. No.: 11/541,603

(22) Filed: Oct. 3, 2006

(30) Foreign Application Priority Data
May 30, 2006 (TW) 95119233

(51) Int. Cl. G11B 7/00

(52) U.S. Cl. 720/677

(57) ABSTRACT

A motor-fixed structure of an optical disc device comprises a substrate, at least two fixing components, and a stepping motor. The substrate has an optical pickup head thereon. The fixing components are aligned erectly on the bearing substrate, and each of the fixing components has a corresponding hole, and the fixing components are integrated with the bearing substrate. Besides, the stepping motor is connected to a lead screw for power transmission so as to drive the optical pickup head to track and read data. And the lead screw is through these holes so as to firmly mount the stepping motor on the fixing components.

### FIELD OF THE INVENTION

The present invention generally relates to a motor-fixed structure, and more particularly to a motor-fixed structure for an optical disc device.

### DESCRIPTION OF THE RELATED ART

The optical disc device is popular and a large demand electronic product for the present market. Due to the competition, the product price must unceasingly come down. How to reduce the making cost to remain proper profits shall be that the dealers constantly think about. The optical disc device is usually fabricated by a lot of mechanical units. Therefore, to improve the fabrication of each unit may aim at the aspect of saving cost. Further more, even reducing a screw or a base element can raise the fabricating speed of the optical disc device or reduce production costs.

Please refer to FIG. 1, it illustrates an exploded view of elements inside an optical disc device in prior arts. The optical disc device has a tray 12, a traverse 13, and a tray moving mechanism 14 so as to constitute the working principle of the optical disc device. The case 10 of the optical disc device has the tray 12 therein for loading discs and being capable of moving back and forth in order to deliver discs by means of the tray moving mechanism 14. When a disc is in the optical disc device, the optical disc device drives an optical pickup head to access stored data of the disc by means of a stepping motor disposed on the traverse 13.

Referring to FIG. 2, it illustrates a schematic top view of a mechanism of the traverse 13 of FIG. 1. The traverse 13 has a base element 131 with a spindle motor 130, a stepping motor 132, an optical pickup head 136, etc. The spindle motor 130 is supported by an adaptor and locked on the base element 131 of the traverse 13. The spindle motor 130 is to support a disc and in high-speed rotations. The stepping motor 132 drives the optical pickup head 136 to track for reading the stored data in the disc.

As shown in the figure, one end of the stepping motor 132 has a lead screw 133, which drives the optical pickup head 136 to track by way of the stepping motor 132 transmitting power. Besides, the stepping motor 132 is set in a fixing seat 134 with a [symbol] -shape, which includes a body and two side planes 1341 and 1342. The two side planes 1341 and 1342 individually have a hole. The lead screw 133 is through to the holes of the two side planes 1341 and 1342 so as to let the stepping motor 132 be firmly mounted on the fixing seat 134. For further description, an outside of the side plane 1341 of the fixing seat 134 urges and fixes the stepping motor 132, the hole of the side plane 1342 is to fix the lead screw 133.

Besides, the body of the fixing seat 134 has two combining holes, and the base element 131 in the traverse 13 also has two combining holes correspondingly. The fixing seat 134 is mounted on the base element 131 of the traverse 13 via that two screws 135 are through the four combining holes.

Due to the stepping motor 132 of the traverse 13 is disposed on the fixing seat 134, and then the fixing seat 134 is firmly mounted on the base element 131 of the traverse 13 by the screws 135. So it takes longer time and more labors to fabricate the optical disc device, thus the cost is raised. Therefore, how to reduce the labor cost, the material cost, the component amount, and fabricating inconvenience to install the stepping motor on the traverse may need the efforts of the persons skilled in the art

### SUMMARY OF THE INVENTION

The objective of the present invention is to provide a motor-fixed structure for effectively reducing components and lowering the fabricating cost.

The present invention is to provide the motor-fixed structure of an optical disc device, which has a substrate, at least two fixing components, and a stepping motor. The substrate has an optical pickup head thereon. The fixing components are aligned erectly on the substrate, and each of the fixing components has a corresponding hole, and the fixing components are integrated with the bearing substrate. Besides, the stepping motor is connected to a lead screw for power transmission so as to drive the optical pickup head to track and read data. And the lead screw is through these holes so as to firmly mount the stepping motor on the fixing components.

Each of the fixing components further has a first fixing component and a second fixing component, the first fixing component is disposed aside the stepping motor, and the second fixing component is disposed at an end of the lead screw. And the first fixing component and the second fixing component are the tabular structures.

Further, the substrate is a sheet metal structure. Said first fixing component and the second fixing component are formed by bending the substrate. The substrate has a hollow section and the stepping motor is accommodated in the hollow section. Additionally, the shape of the hollow section matches up the shape of the stepping motor.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 illustrates an exploded view of elements inside an optical disc device in prior arts;

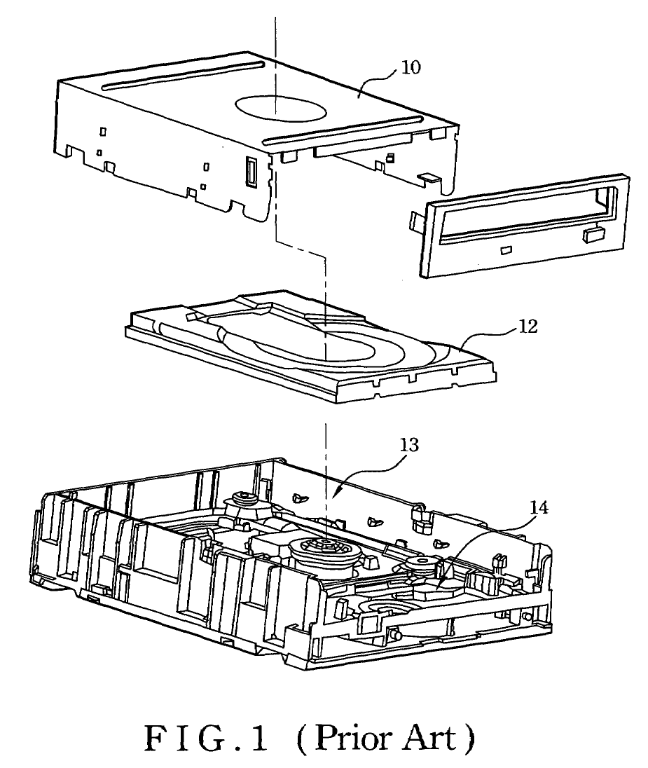

FIG. 2 it illustrates a schematic top view of a mechanism of a traverse of FIG. 1

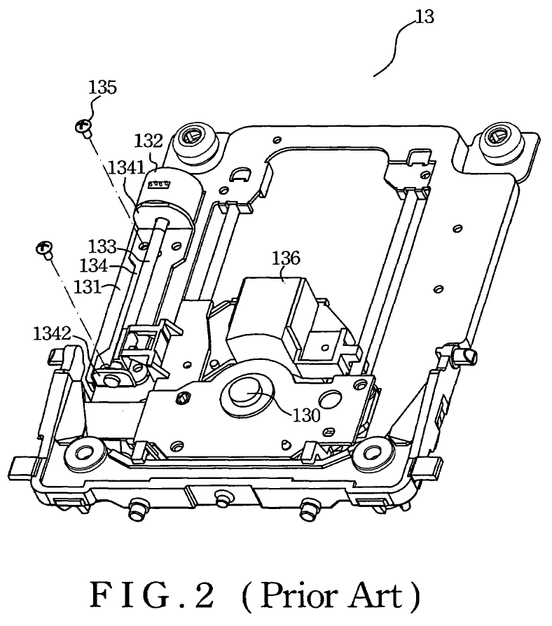

FIG. 3a illustrates a schematic top view of a motor-fixed structure in an optical disc device of the present invention;

FIG. 3b illustrates a schematic bottom view of the motor-fixed structure in the optical disc device of the present invention; and

FIG. 3c illustrates another schematic top view of the motor-fixed structure in the optical disc device of the present invention.

### DETAILED DESCRIPTIONS OF THE PREFERRED EMBODIMENTS

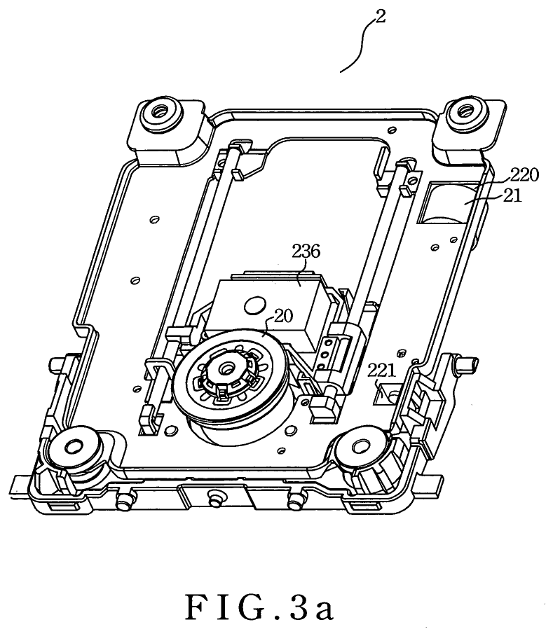

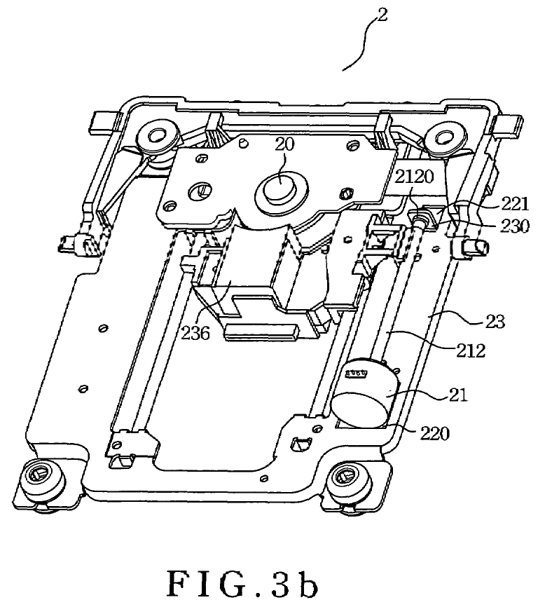

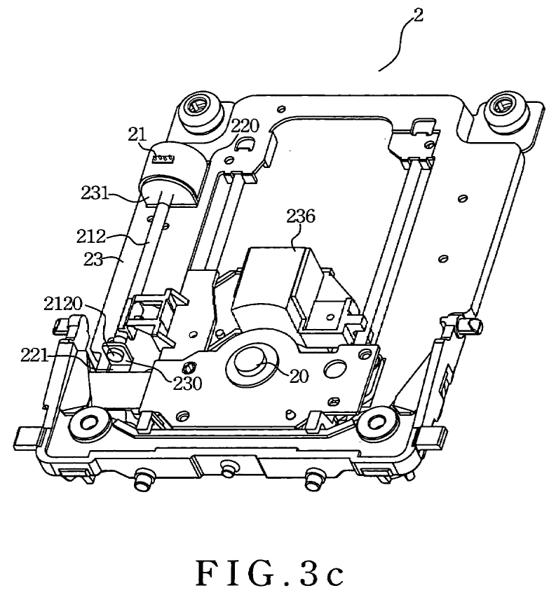

Please refer to FIGS. 3a to 3c, which illustrate a schematic top view of a motor-fixed structure in an optical disc device of the present invention, a schematic bottom view of the motor-fixed structure in the optical disc device of the present invention and another schematic top view of the motor-fixed structure in the optical disc device of the present invention.

In the preferred embodiment, the motor-fixed structure has a substrate 23, two fixing components 230 and 231, and a stepping motor 21. A traverse 2 includes the substrate 23, and other elements inside the traverse 2 are disposed on the substrate 23. The stepping motor 21 is accommodated in a hollow section 220 of the substrate 23, and one end of the stepping motor 21 has a lead screw 212. The stepping motor 21 is connected to a lead screw 212 for power transmission so as to drive the optical pickup head 236 to track and read data. The fixing components 230 and 231 are aligned erectly on a surface of the substrate 23, and each of the fixing components has a corresponding hole thereon. In the preferred embodiment, the fixing components 230 and 231 respectively are defined as a first fixing component 231 and a second fixing component 230. The first fixing component 231 is set beside the hollow section 220 where is the connection of the stepping motor 21 and the lead screw 212. The lead screw 212 is directly through the hole of the first fixing component 231; the second fixing component 230 is disposed at an end 2120 of the lead screw 212. The lead screw 212 is through these holes so as to restrict the stepping motor 21 and the lead screw 212 moving, and then the stepping motor 21 and the lead screw 212 are firmly mounted on the substrate 23.

According to the embodiment, the first fixing component 231 is a tabular structure, and the first fixing component 231 is integrated with the substrate 23; the second fixing component 230 also is a tabular structure and integrated with the bearing substrate 23. The second fixing component 230 is disposed beside another hollow section 221.

Continuously, the substrate 23 is a sheet metal structure. Said first fixing component 231 and the second fixing component 230 are formed by bending the substrate 23. The first fixing component 231 and the second fixing component 230 are aligned erectly on the substrate 23.

To be noted for the motor-fixed structure in the optical disc device of the present invention, the substrate 23 of the traverse 2 is directly formed as the needed for the stepping motor 21 by bending or other ways. Therefore, the stepping motor 21 can be directly fabricated on the substrate 23 without other prefixing components for the stepping motor 21.

As a conclusion, base on the motor-fixed structure in the optical disc device of the present invention, due to the fixing components are directly formed on the substrate of the traverse, and the direct fabrication of the substrate and the stepping motor, the screws and other fixing elements for the stepping motor may be saved in order to decrease the cost. In the whole thinking, the present invention reduces the produced cost and raises the product gross profits.

While the present invention has been particularly shown and described with reference to a preferred embodiment, it will be understood by those skilled in the art that various changes in form and detail may be without departing from the spirit and scope of the present invention.

I claim:

1. A motor-fixed structure of an optical disc device, comprising:
a substrate having an optical pickup head thereon;
at least two fixing components being aligned erectly on the bearing substrate and integrated with the substrate, wherein each of the fixing components has a corresponding hole; and
a stepping motor being connected to a lead screw for power transmission so as to drive the optical pickup head to track and read data;
wherein the lead screw is through the holes so as to firmly mount the stepping motor on the fixing component.

2. The motor-fixed structure according to claim 1, wherein said fixing component further comprises a first fixing component and a second fixing component, wherein the first fixing component is disposed aside the stepping motor, and the second fixing component is disposed at an end of the lead screw.

3. The motor-fixed structure according to claim 2, wherein said first fixing component is a tabular structure.

4. The motor-fixed structure according to claim 2, wherein said second fixing component is a tabular structure.

5. The motor-fixed structure according to claim 1, wherein said substrate is a sheet metal structure.

6. The motor-fixed structure according to claim 1, wherein said fixing component are formed by bending the substrate.

7. The motor-fixed structure according to claim 1, wherein said substrate has a hollow section, and the stepping motor is accommodated in the hollow section.

8. The motor-fixed structure according to claim 7, wherein said shape of the hollow section matches up the shape of the stepping motor.
